(19) United States
(12) Patent Application Publication
(10) Pub. No.: US 2008/0228937 A1
(43) Pub. Date: Sep. 18, 2008

(54) IMAGE PROCESSING APPARATUS AND LOG TRANSFER METHOD

(76) Inventor: Yuichi Araumi, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/854,103

(22) Filed: Sep. 12, 2007

(30) Foreign Application Priority Data
Sep. 13, 2006 (JP) 2006-248613

(51) Int. Cl. G06F 15/16

(52) U.S. Cl. 709/232

(57) ABSTRACT

An image processing apparatus is disclosed. In the image processing apparatus, a log transfer part transfers log information, and a transfer method changing part changes a transfer method used by the log transfer part, based on a factor of a network load caused by a log transfer.

### BACKGROUND OF THE INVENTION

1. Field of the Invention

The present invention generally relates to an image processing apparatus and a log transferring method, which can reduce a network load caused by a log information amount and a communication frequency in a log transfer process for transferring log information to a log collecting server connected through a network.

2. Description of the Related Art

Recently, an image processing apparatus including various functions such as a printer, a copier, a facsimile, a scanner, and a like can be connected to a network such as the Internet, a LAN (Local Area Network), or a like, and a client terminal can utilize the image processing apparatus through the network. In order to maintain a utilization state of the image processing apparatus and secure data in the image processing apparatus, the image processing apparatus generally records log information such as a job log, an access log, and a like. For example, Japanese Laid-open Patent Application No. 2002-149380 describes an image processing apparatus that records the log information.

In a general image processing apparatus, since a storage capacity (hereinafter, called a log information storage capacity) used to record the log information is smaller, when the log information storage capacity becomes in a shortage state, it is required to delete old log information to record new log information. In addition, the log information being recorded in the image processing apparatus is not highly secure. Accordingly, the image processing apparatus conventionally transfers to a log collecting server which has a larger storage capacity for recording log information and has a higher reliability to record log information, though the network.

As a log information transfer method, a method for periodically transferring the log information, and a method for successively transferring the log information are considered.

In a case of the periodical transfer, when a large amount of log information is generated during a transfer interval, it is required to transfer the large amount of log information at a next transfer time. Thus, there is a problem of increasing the network load. Moreover, even if a log having a high priority such as a security log is generated during the transfer interval, the log is not transferred until a defined time. Thus, there is a problem in that an administrator cannot timely comprehend contents of log information being highly urgent.

In a case of the successive transfer, if every communication result, which includes a log transfer result indicating a success or failure of transferring the log information is logged and successively transferred, a log transfer is frequently occurred. Thus, there is a problem in that a load of a transfer process is increased.

### SUMMARY OF THE INVENTION

The present invention solves or reduces one or more of the above problems.

According to one aspect of the present invention, there is provided an image processing apparatus, including: a log transfer part configured to transfer log information; and a transfer method changing part configured to change a transfer method used by the log transfer part, based on a factor of a network load caused by a log transfer.

Therefore, it is possible to reduce the network load in the log transfer for transferring log information through a network.

In the image processing apparatus, a transfer interval may be set to be shorter based on an accumulation amount of logs which is a factor of the network load. Moreover, in the image processing apparatus, the log transfer may be changed from a periodical transfer to a successive transfer, and the log transfer may be conducted in that the transfer interval is shorter than the periodical transfer.

Moreover, in the image processing apparatus, only a higher priority log may be transferred based on the accumulation amount of logs which is the factor of the network load. Furthermore, in the periodical transfer, a log other than the log being higher priority may be transferred at a next periodical transfer.

In the image processing apparatus, a security log may be transferred at a shorter transfer interval. Moreover, in the image processing apparatus, in the periodical transfer, the security log may be transferred by changing the log transfer method to a successive transfer.

In the image processing apparatus, in communication logs transferred as security logs, a communication result log indicating a communication result may be transferred by a different log transfer from a log transfer for transferring a communication log other than the communication result log. Moreover, in the image processing apparatus, the communication log other than the communication result log may be transferred by the successive transfer, and the communication result log is transferred by the periodical transfer. Alternatively, in the image processing apparatus, when the communication log other than the communication result log is transferred, the communication result log may be transferred.

In the image processing apparatus, in the log transfer method of one of the periodical transfer and the successive transfer, a transfer timing is changed based on the accumulation amount of logs or the log type. Therefore, it is possible to reduce the network load caused by the log transfer.

### BRIEF DESCRIPTION OF THE DRAWINGS

In the following, embodiments of the present invention will be described with reference to the accompanying drawings.

FIG. 1 is a diagram for explaining a log transfer system according to an embodiment of the present invention;

FIG. 2 is a block diagram showing a functional configuration of an image processing apparatus according to the embodiment of the present invention;

FIG. 3 is a block diagram showing a hardware configuration of an image processing apparatus according to the embodiment of the present invention;

FIG. 4 is a diagram for explaining a successive transfer of logs;

FIG. 5 is a diagram for explaining a transfer pattern 1 in that a transfer method is switched from a periodical transfer to the successive transfer based on a generation amount of logs, according to the embodiment of the present invention;

FIG. 6 is a diagram for explaining a transfer pattern 2 in that a higher priority log is first sent out at the time of the periodical transfer, according to the embodiment of the present invention;

FIG. 7 is a diagram for explaining a transfer pattern 3 in that logs are sent out by a transfer method corresponding to log types, according to the embodiment of the present invention;

FIG. 8 is a diagram for explaining a transfer pattern 4 in that communication logs of security logs subject to the successive transfer are sent out by the periodical transfer, according to the embodiment of the present invention;

FIG. 9 is a diagram for explaining a transfer pattern 5 in that when logs other than the communication logs are generated, the successive transfer is conducted to send out the logs together with communication logs being accumulated, according to the embodiment of the present invention;

FIG. 10A is a diagram for explaining a module relationship concerning a regular log when an event occurs in each of applications, according to the embodiment of the present invention, and FIG. 10B is a diagram showing an internal configuration of the log transfer module and explaining a data flow for the regular log, according to the embodiment of the present invention;

FIG. 11A is a diagram for explaining a module relationship in a case in that an event occurs in response to an operation of a user at an operation panel, according to the embodiment of the present invention, and FIG. 11B is a diagram showing a dataflow of an access log occurred by the operation of the user, in which each of event occurrence modules occurs an event, according to the embodiment of the present invention;

FIG. 12A is a diagram for explaining a module relationship concerning an event occurrence in a process requested through a network, according to the embodiment of the present invention, and FIG. 12B is a diagram showing a dataflow of a communication log occurred by the process requested through the network, according to the embodiment of the present invention;

FIG. 13 is a diagram showing a sequence example for conducting the transfer pattern 1 shown in FIG. 5, according to the embodiment of the present invention;

FIG. 14 is a diagram showing another sequence example for conducting the transfer pattern 1 shown in FIG. 5, according to the embodiment of the present invention;

FIG. 15 is a diagram showing a sequence example for conducting the transfer pattern 2 shown in FIG. 6, according to the embodiment of the present invention;

FIG. 16 is a diagram showing a sequence example for conducting the transfer pattern 3 shown in FIG. 7, according to the embodiment of the present invention;

FIG. 17 is a diagram showing a sequence example for conducting the transfer pattern 1 shown in FIG. 8, according to the embodiment of the present invention;

FIG. 18 is diagram showing a sequence example for conducting the transfer pattern 5 shown in FIG. 9, according to the embodiment of the present invention; and

FIG. 19A, FIG. 19B and FIG. 19C are diagrams showing data structures of the log information according to the embodiment of the present invention

### DESCRIPTION OF THE PREFERRED EMBODIMENT

In the following, an embodiment of the present invention will be described with reference to the accompanying drawings.

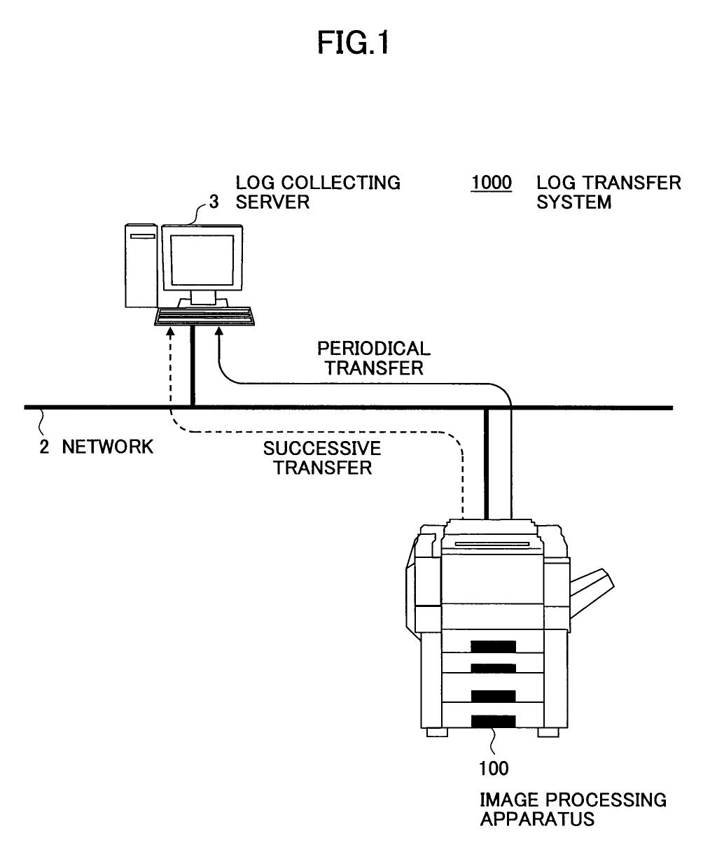

For example, a log transfer system according to the embodiment of the present invention is configured as shown in FIG. 1. FIG. 1 is a diagram for explaining the log transfer system according to the embodiment of the present invention. In the log transfer system shown in FIG. 1, an image processing apparatus 100 including various image processing functions such as a printer, a copier, a facsimile, a scanner, and alike is connected to a log collecting server 3 through a network 2.

The log collecting server 3 includes a storage unit having a large capacity, and receives and stores log information of a job log, an access log, and a like from the image processing apparatus 100 in order to comprehend a utilization state of the image processing apparatus 100 and secure the image processing apparatus 100.

The image processing apparatus 100 conducts a periodical transfer or a successive transfer of log information based on an accumulation state of the log information, a log type, and a like.

In a periodical transfer mode, when a large amount of logs are generated during a transfer interval and log information is greatly accumulated so that a heavier load is given to a network communication if transferring at once, the periodical transfer mode is switched to a successive transfer mode. Then, instead of giving the heavier load to the network communication, the log information being accumulated is transferred to the log collecting server 3 more frequently than the periodical transfer.

Alternately, a log type is determined and the log information concerning a log of a higher priority is transferred to the log collecting server 3 at a time of the periodical transfer. On the other hand, the log information concerning a log of a lower priority is transferred at a next periodical transfer. As described above, by transferring the logs of the higher priority at the time of the periodical transfer, it is possible to suppress the load of the network communication.

Moreover, in the periodical transfer mode, the log type is determined and the log information concerning the log of the high priority such as a security log is transferred to the log collecting server 3 by the successive transfer. Since the log of the higher priority is transferred to the log collecting server 3, instead of waiting for a timing of a next periodical transfer, it is possible for the log collecting server 3 to timely notify an urgent state of the image processing apparatus 100 of an administrator.

For example, in the successive transfer mode, if a communication result indicating a success or failure of transferring the log information, which is one type of the security log, is sent as the communication log to the log collecting server 3, it is frequently repeated to transfer another communication result caused by transferring the communication result, as the communication log every after the log transfer is conducted.

In the embodiment, by sending the communication result together with the log information subject to the periodical transfer other than the communication log to the log collecting server 3 at a timing of the periodical transfer, it is possible to reduce a frequency of transferring the communication log and improve the network load.

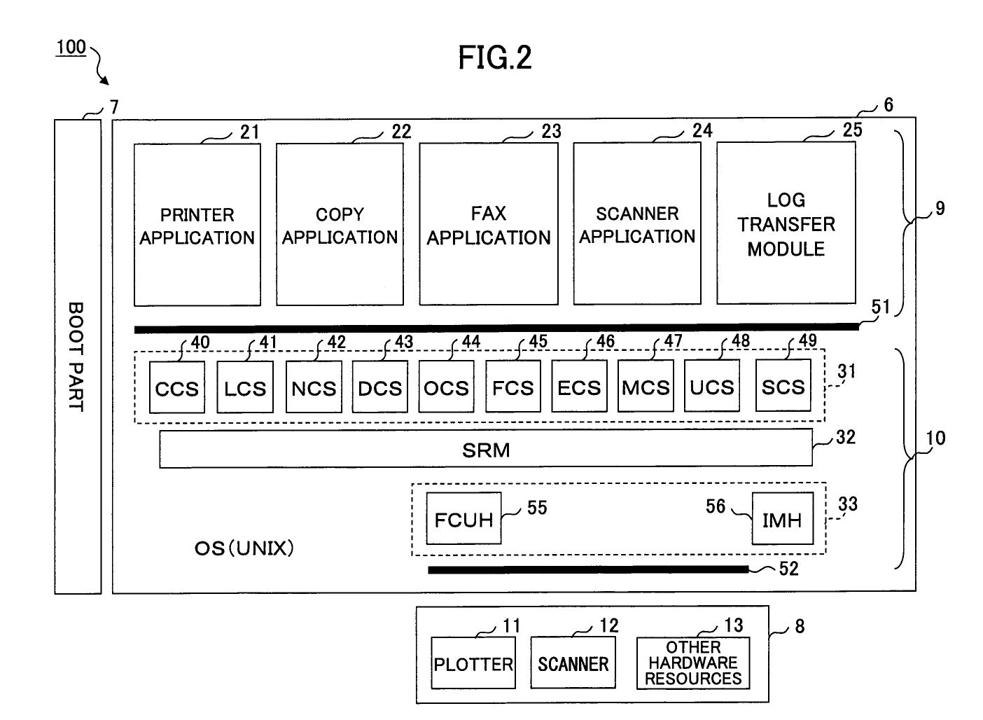

FIG. 2 is a block diagram showing a functional configuration of the image processing apparatus according to the embodiment of the present invention. The image processing apparatus 100 includes a software group 6, a boot part 7, and hardware resources 8.

The hardware resources 8 include a plotter 11, a scanner 12, and other hardware resources 13 including a facsimile. The software group 6 includes an application layer 9 and a platform 10 being activated on an OS (Operating System) such as UNIX™. The application layer 9 includes programs for conducting processes concerning image formations such as the printer, the copier, the facsimile, the scanner, and the like or processes concerning Web services.

In FIG. 2, the application layer 9 includes a printer application 21, a copy application 22, a FAX application 23, a scanner application 24, and a log transfer module 25 as an application.

The platform 10 includes a control service layer 31 for interpreting a request from the application layer 9 and generating an acquisition request of the hardware resources 8, an SRM (System Resource Manager) 32 for managing the hardware resources 8 and mediating the acquisition request from the control service layer 31, and a handler layer 33 for managing the hardware resources 8 in response to the acquisition request received from the SRM 32.

The control service layer 31 includes one or more service modules such as a CCS (Certificate Control Service) 40, LCS (Log Control Service) 41, an NCS (Network Control Service) 42, a DCS (Delivery Control Service) 43, an OCS (Operation panel Control Service) 44, an FCS (FAX Control Service) 45, an ECS (Engine Control Service) 46, an MCS (Memory Control Service) 47, a UCS (User information Control Service) 48, and an SCS (System Control Service) 49.

The platform 10 further includes an API (Application Program Interface) 51 for receiving the request from the application layer 9 by using a predetermined function. The OS executes various software applications of the application layer 9 and the platform 10 as processes in parallel.

A process of the CCS 40 conducts a user authentication to allow a user to use the image processing apparatus 100.

A process of the LCS 41 generates the log information in response to an event received from event generation modules of other control services and other software applications, and manages the log information.

A process of the NCS 42 mediates to distribute data received by each protocol from the network 2 to each application, and mediates data from each application to the network 2.

A process of the DCS 43 controls a delivery of document data accumulated in the image processing apparatus 100.

A process of the OCS 44 controls an operation panel, which will be described later.

A process of the FCS 45 provides an API for transmitting by a facsimile using a PSTN (Public Switched Telephone Network) or an ISDN (Integrated Services Digital Network) network from the application layer 9, registering and utilizing various fax data managed in a memory for a backup, reading a fax document, and receiving and printing out a facsimile.

A process of the ECS 46 controls the plotter 11, the scanner 12, and other hardware resources 13 such as engine parts.

A process of the MCS 47 controls acquiring and releasing a memory, accessing an HDD (Hard Disk Device), compressing and decompressing image data.

A process of the UCS 48 manages user information.

A process of the SCS 49 conducts processes such as a control of an operation part, a display of a system screen, an LED display, a management of the hardware resources 8, a management of applications, a control of interruption applications.

A process of the SRM 32 conducts a system control and a management of the hardware resources 8 with the SCS 49. For example, the process of the SRM 32 controls executions of the hardware resources 8 by mediating in accordance with an acquisition request to using the hardware resources 8 such as the plotter 11, the scanner 12, and the like, from an upper layer.

In detail, the process of the SRM 32 determines whether or not the hardware resources 8 required by the acquisition request are available (are being used by another acquisition request). If available, the process of the SRM 32 informs the upper layer that the hardware resources 8 are available. The process of the SRM 32 makes a schedule to use the hardware resources 8 for the acquisition request received from the upper layer, and directly conducts a request process (a sheet carriage and an imaging operation by a printer engine, a memory reservation, a file generation, and a like).

Moreover, the handler layer 33 includes an FCUH (FAX Control Unit Handler) 55 for managing a FCU (FAX Control Unit), and an IMH (Image Memory Handler) 56 for managing an assignment of a memory area for each process.

The SRM 32 and the FCUH 55 make a request for the hardware resources 8 by using an engine I/F (InterFace) 52 which sends the request to the hardware resources 8 by a predetermined function. By the functional configuration shown in FIG. 2, in the image processing apparatus 100, it is possible for the platform 10 to collectively conduct processes which are necessary in common in each of applications.

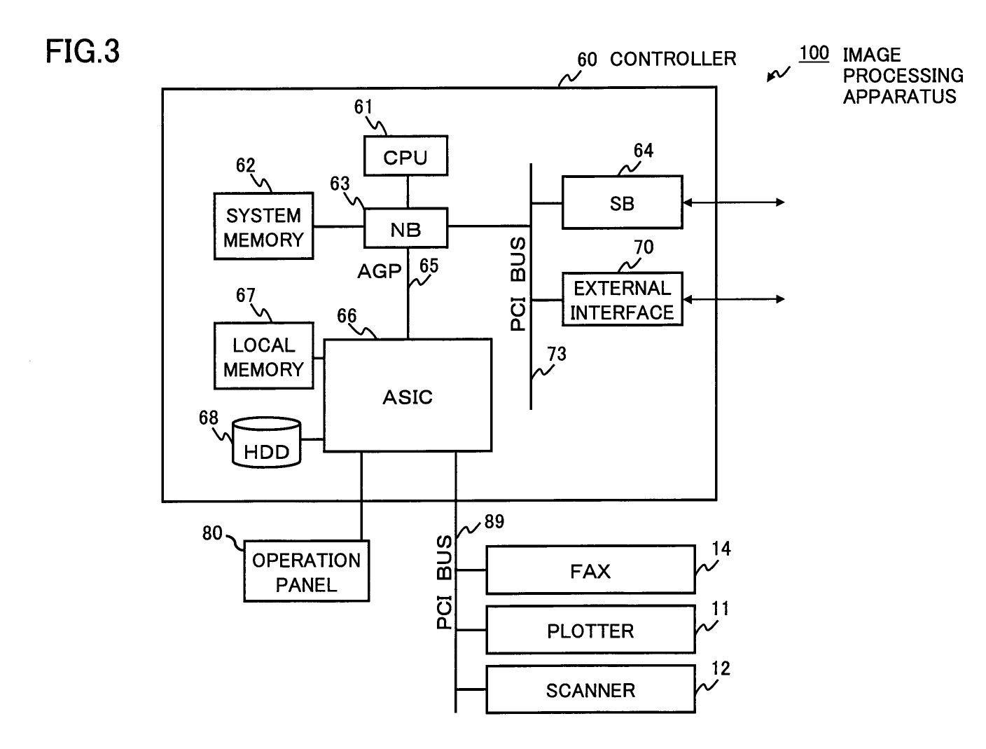

FIG. 3 is a block diagram showing a hardware configuration of the image processing apparatus according to the embodiment of the present invention. In FIG. 3, the image processing apparatus 100 includes a controller 60, an operation panel 80, the plotter 11, the scanner 12, and a FAX 14.

The controller 60 includes a CPU (Central Processing Unit) 61, a system memory 62, an NB (North Bridge) 63, an SB (South Bridge) 64, an ASIC (Application Specific Integrated Circuit) 66, a local memory 67, an HDD (Hard Disk Device) 68, and an external interface 70.

The operation panel 80 is connected to the ASIC 66 of the controller 60. The FAX 14, the plotter 11, and the scanner 12 are connected to the ASIC 66 of the controller 60 via a PCI (Peripheral Component Interconnect) bus 89.

In the controller 60, the local memory 67 and the HDD 68 are connected to the ASIC 66. The CPU 61 and the ASIC 66 are connected to each other via the NB 63 of the CPU chip set. The ASIC 66 and the NB 63 are connected through an AGP (Accelerated Graphics Port) 65.

The CPU 61 controls the entire image processing apparatus 100. The NB 63 is a bridge to connect the CPU 61, the system memory 62, the SB 64, the ASIC 66, and the external interface 70 to each other. The NB 63 connects the external interface 70 via a PCI (Peripheral Components Interconnect) bus 73. The SB 64 is a bridge to connect a ROM (Read Only Memory), peripheral devices, and a like to the PCI bus 73.

The system memory 62 is a memory to drawing images. The local memory 67 is a memory used as an image buffer for a copy, and an encoding buffer. The ASIC 66 is an IC (Integrated Circuit) including a hardware element for an image process and used to conduct the image process. The HDD 68 is storage (auxiliary storage unit) for accumulating image data, document data, programs, font data, forms, and a like.

The external interface 70 is an interface device for connecting the image processing apparatus 100 to the Internet, a LAN (Local Area Network), and a like. The operation panel 80 is an operation part which receives data input by a user and displays information to the user.

Transfer patterns to solve conventional problems in the periodical transfer and the successive transfer will be described.

(A) Problems and Solutions in the Periodical Transfer:

(Conventional Problem A-1)

When a large amount of logs are generated during a transfer interval of the periodical transfer, a network load is greatly increased at a next periodical transfer.

(Solution in the Present Invention)

Transfer Pattern 1: A transfer timing is divided based on an amount of generated logs. For example, the transfer interval of the periodical transfer is set to be shorter so as to increase a log transfer frequency. Alternatively, when logs are massively generated, a transfer method is switched to the successive transfer.

Transfer Pattern 2: A log type is determined to send out a higher priority log first at a time of the periodical transfer. First, the higher priority log is sent out at the time of the periodical transfer while other types of logs remain. When an accumulation amount of logs is decreased by sending out the higher priority logs, logs which are not transferred are scheduled to be sent out at the next periodical transfer.

(Conventional Problem A-2) Even if there are the higher priority logs such as security logs, the higher priority logs are not transfer until the time of the periodical transfer. Thus, it is impossible for an administrator to timely comprehend important information.

(Solution in the Present Invention)

Transfer Pattern 3: The log type is determined and each log is transferred based on the log type. The transfer interval of the periodical transfer is set to be shorter to send out the higher priority logs. Alternatively, the transfer method is switched to the successive transfer only for the higher priority logs, and the periodical transfer is conducted for other types of logs.

(B) Problems and Solutions in the Successive Transfer:

(Conventional Problem B-1)

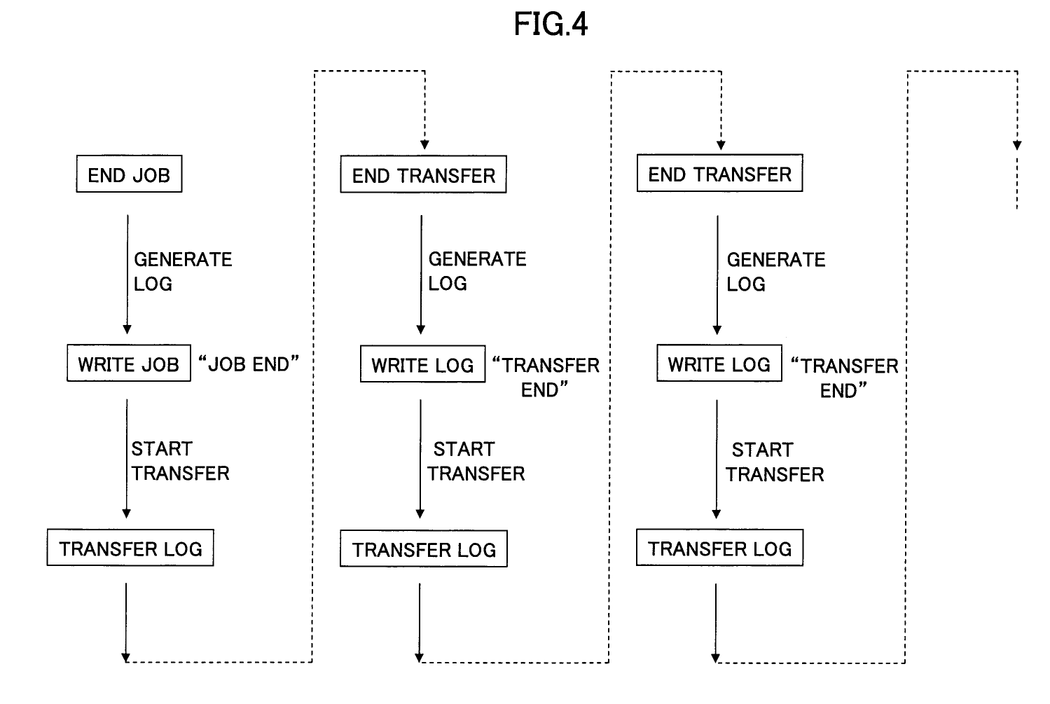

When the successive transfer is conducted for a communication log indicating a communication result as one type of the security log, the log transfer is frequently repeated. For example, as shown in FIG. 4, the image processing apparatus 100 generates a log when a job ends, and writes and accumulates the log indicating the job end. A new log is generated when the log being accumulated is transferred to the log collecting server 3, and a new log indicating a transfer end is written and accumulated. Then, the successive transfer is conducted to send out the new log to the log collecting server 3. Accordingly, in response to a transfer end of the log indicating a previous transfer ends, a further new log indicating a further transfer end is written and the successive transfer is conducted for the further new log. The successive transfer is repeated for the log indicating this transfer end with respect to the further new log.

(Solution in the Present Invention)

Transfer Pattern 4: The successive transfer is suppressed with respect to the communication log, which is one of security logs. Instead, the periodical transfer is conducted to send out the communication log.

Transfer Pattern 5: When a log other than the communication log is generated, the successive transfer is conducted to send out the log together with the communication logs being accumulated.

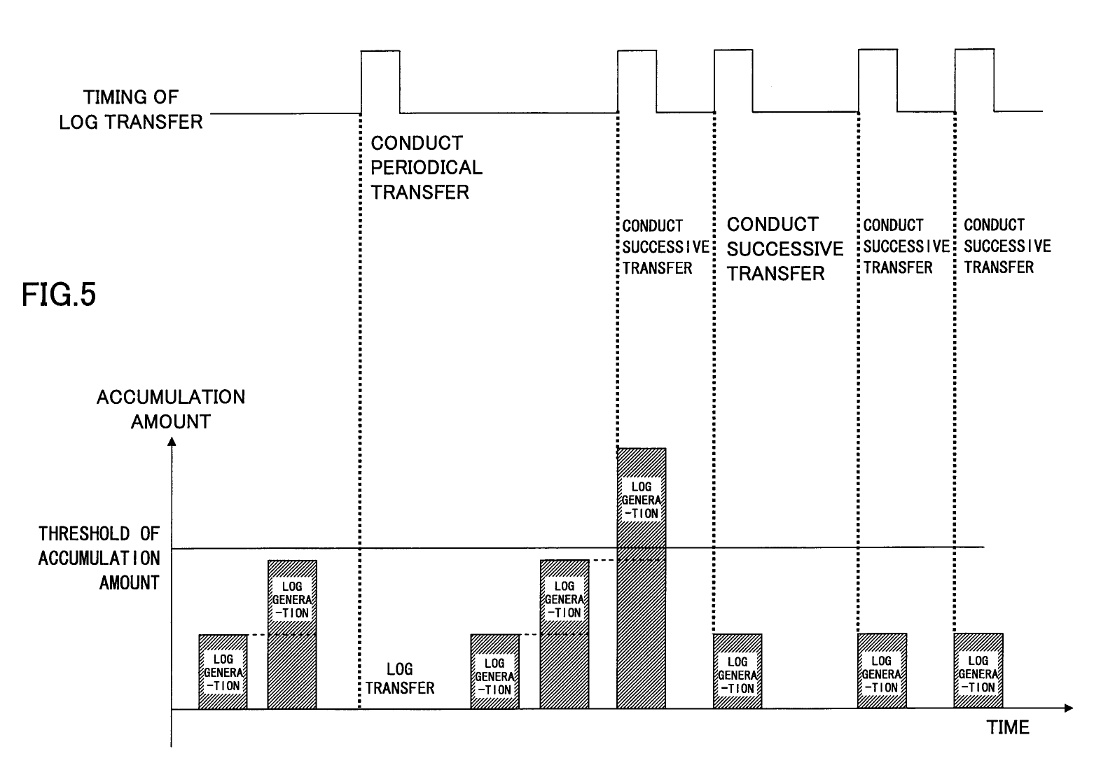

The transfer patterns 1 through 5 will be described with reference to FIG. 5 through FIG. 9.

FIG. 5 is a diagram for explaining the transfer pattern 1 in that the transfer method is switched from the periodical transfer to the successive transfer based on the generation amount of the logs, according to the embodiment of the present invention. In the transfer pattern 1 shown in FIG. 5, logs being accumulated are transferred from the image processing apparatus 100 to the log collecting server 3 at the time of the periodical transfer. After that, when logs are massively generated and the accumulation amount of logs exceeds a threshold of the accumulation amount, the image processing apparatus 100 switches the transfer method from the periodical transfer to the successive transfer to send out the logs being accumulated, to the log collecting server 3.

After switching from the periodical transfer to the successive transfer, the image processing apparatus 100 successively transfers a log to the log collecting server 3 when the log is generated.

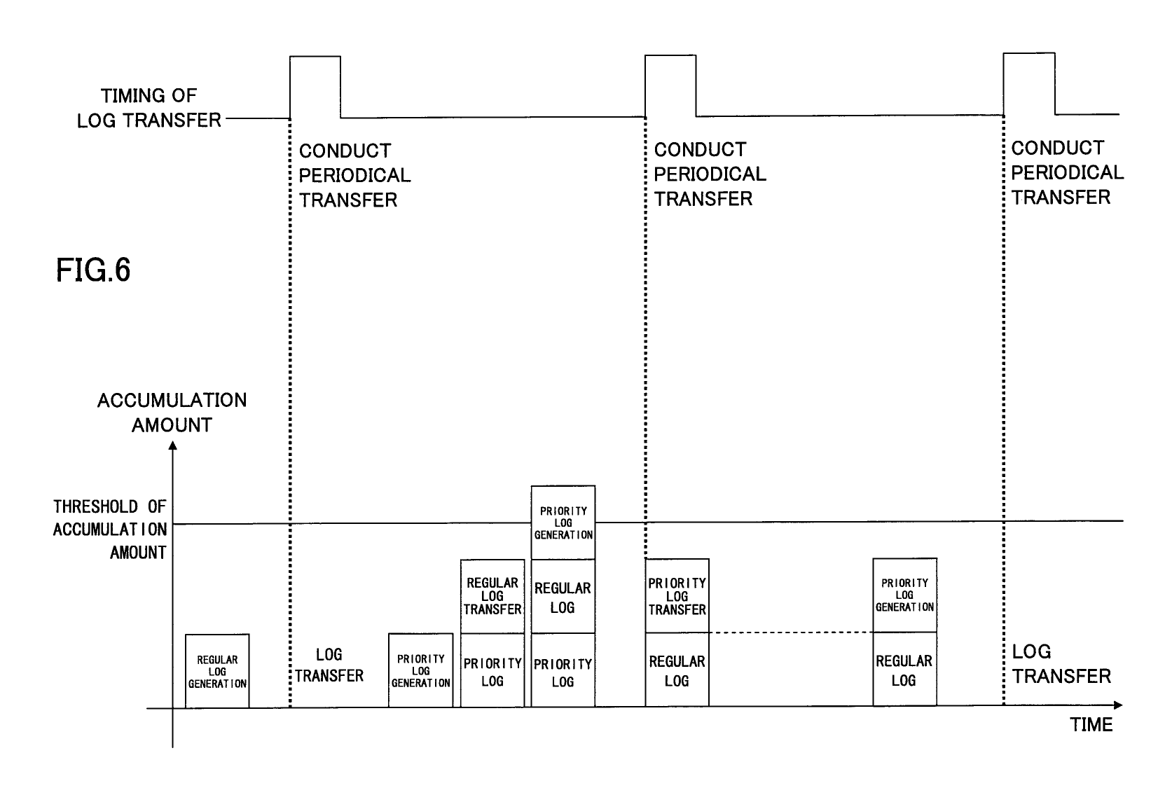

FIG. 6 is a diagram for explaining the transfer pattern 2 in that the higher priority log is first sent out at the time of the periodical transfer, according to the embodiment of the present invention. In the transfer pattern 2 shown in FIG. 6, the image processing apparatus 100 transfers all logs, which are accumulated, to the log collecting server 3, if the accumulation amount of logs does not exceed the threshold of the accumulation amount at the time of the periodical transfer.

However, when the accumulation amount of logs exceeds at the time of the periodical transfer, the image processing apparatus 100 transfers the higher priority logs (hereinafter, called priority logs) of logs being accumulated, to the log collecting server 3. On the other hand, the image processing apparatus 100 retains logs (hereinafter, called regular logs) other than the priority logs to be accumulated. If the accumulation amount of the logs exceeds the threshold at a next periodical transfer, the image processing apparatus 100 transfers the regular logs being accumulated, to the log collecting server 3.

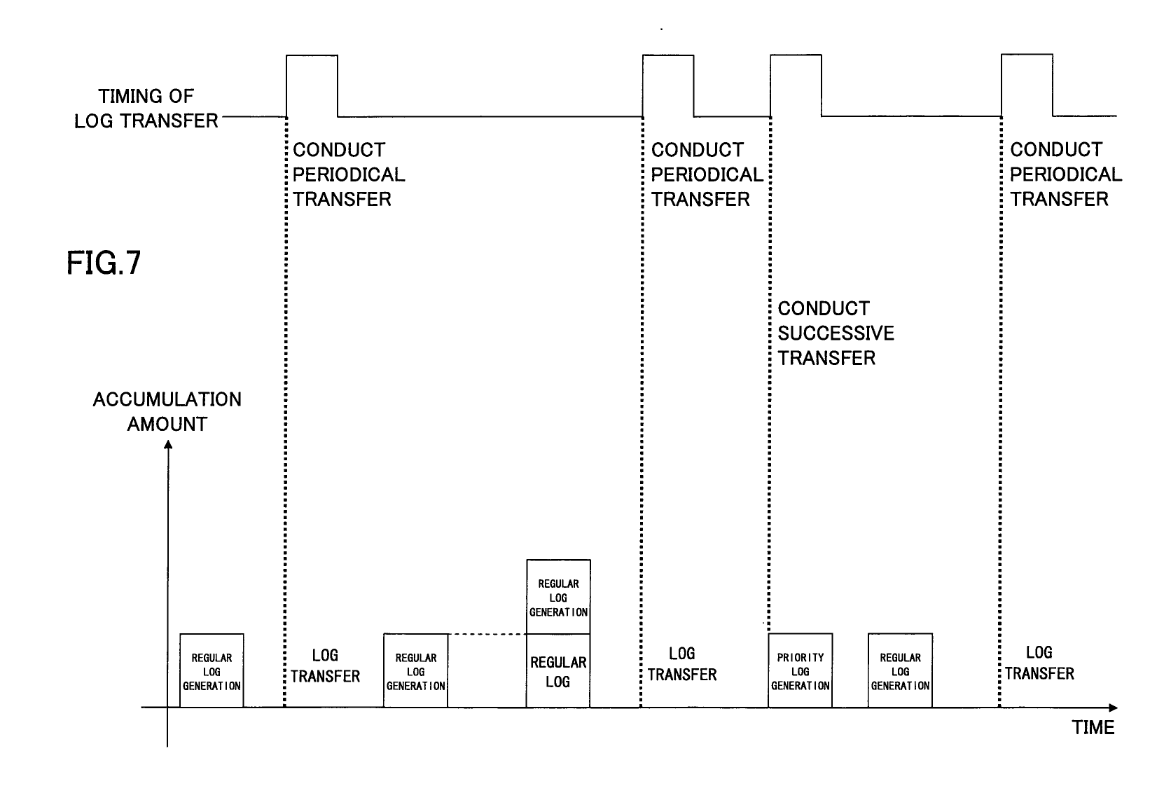

FIG. 7 is a diagram for explaining the transfer pattern 3 in that the logs are sent out by the transfer method corresponding to the log types, according to the embodiment of the present invention. In the transfer pattern 3 shown in FIG. 7, the image processing apparatus 100 retains the regular logs to be accumulated. The regular logs are transferred to the log collecting server 3 at the time of the periodical transfer. On the other hand, the image processing apparatus 100 conducts the successive transfer to send out a priority log to the log collecting server 3 when the priority log is generated.

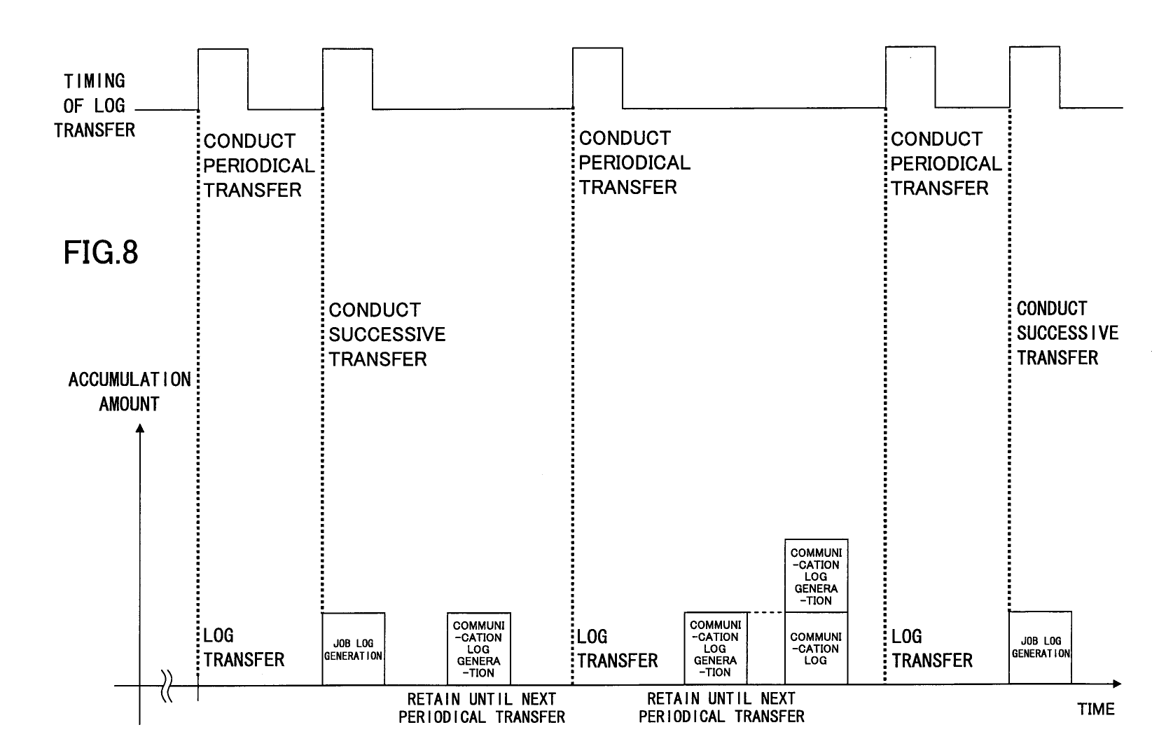

FIG. 8 is a diagram for explaining the transfer pattern 4 in that the communication logs of the security logs subject to the successive transfer are sent out by the periodical transfer, according to the embodiment of the present invention. In the transfer pattern 4 shown in FIG. 8, the image processing apparatus 100 conducts the successive transfer to send out a log (hereinafter, called job log) indicating the job end, when the job log as one of the security logs is generated.

However, even if the communication log indicating the transfer end for the job log is generated, the image processing apparatus 100 suppresses the successive transfer and maintains the communication log until a timing of a next periodical transfer. The image processing apparatus 100 sends out the communication log being accumulated, to the log collecting server 3 at the next periodical transfer.

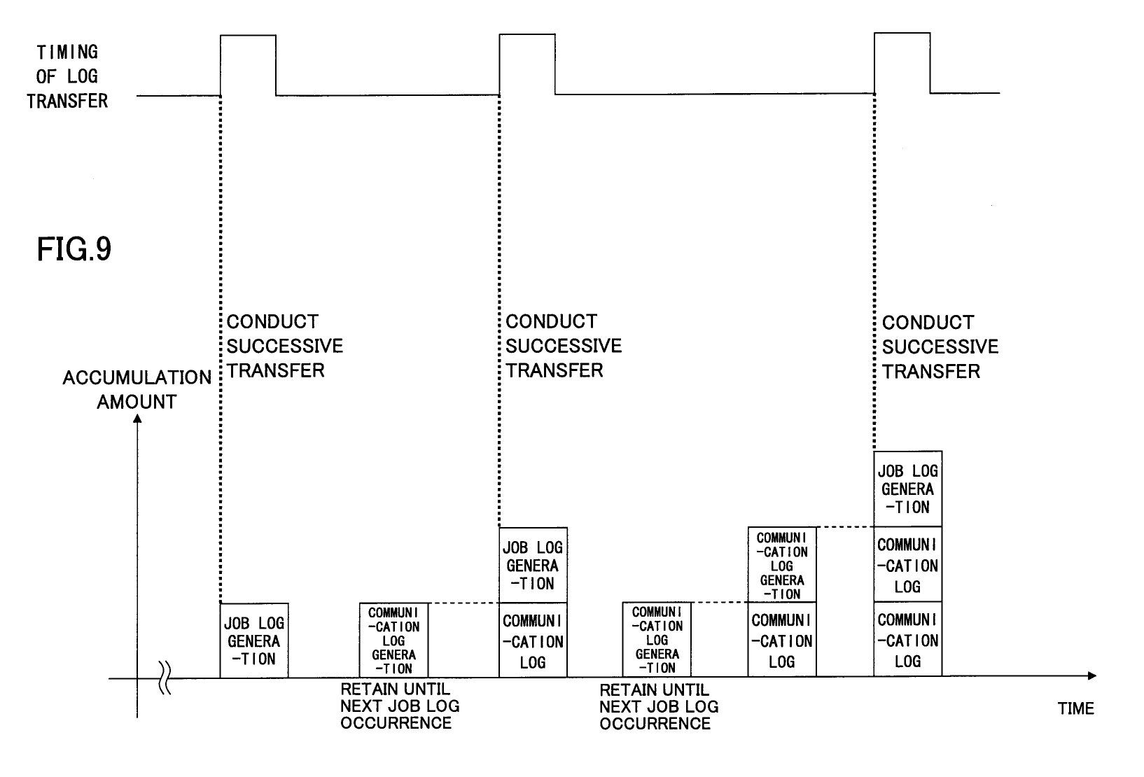

FIG. 9 is a diagram for explaining a transfer pattern 5 in that when logs other than the communication logs are generated, the successive transfer is conducted to send out the logs together with communication logs being accumulated, according to the embodiment of the present invention. In the transfer pattern 5 shown in FIG. 9, the image processing apparatus 100 conducts the successive transfer to send out a job log to the log collecting server 3 when the job log is generated. On the other hand, when a communication log is generated, the communication log is retained until a next job log. When the next job log is generated, the image processing apparatus 100 conducts the successive transfer to send out the communication log being accumulated, together with the job log to the log collecting server 3.

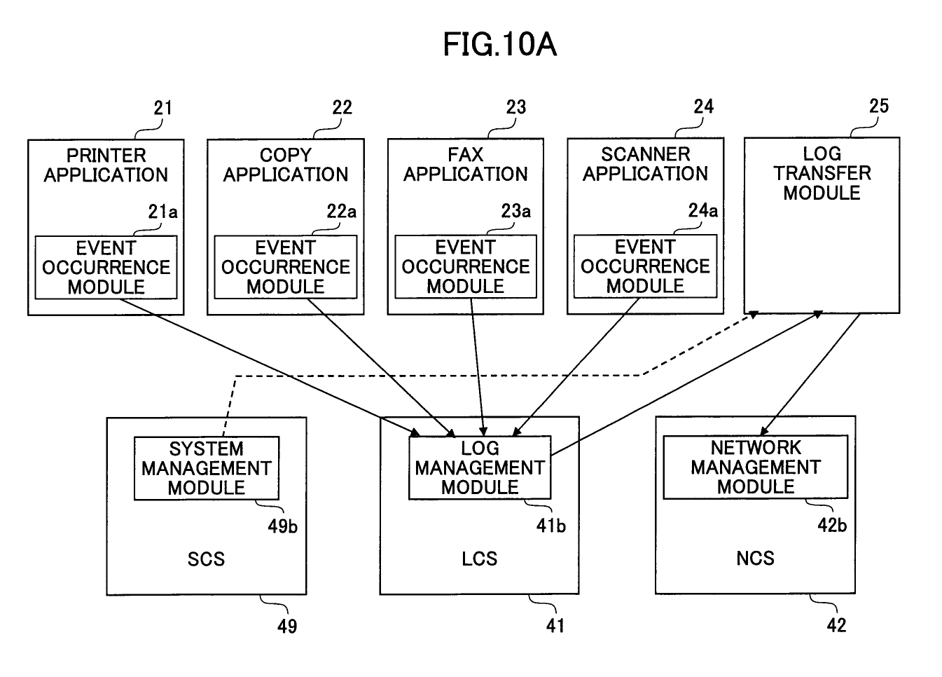

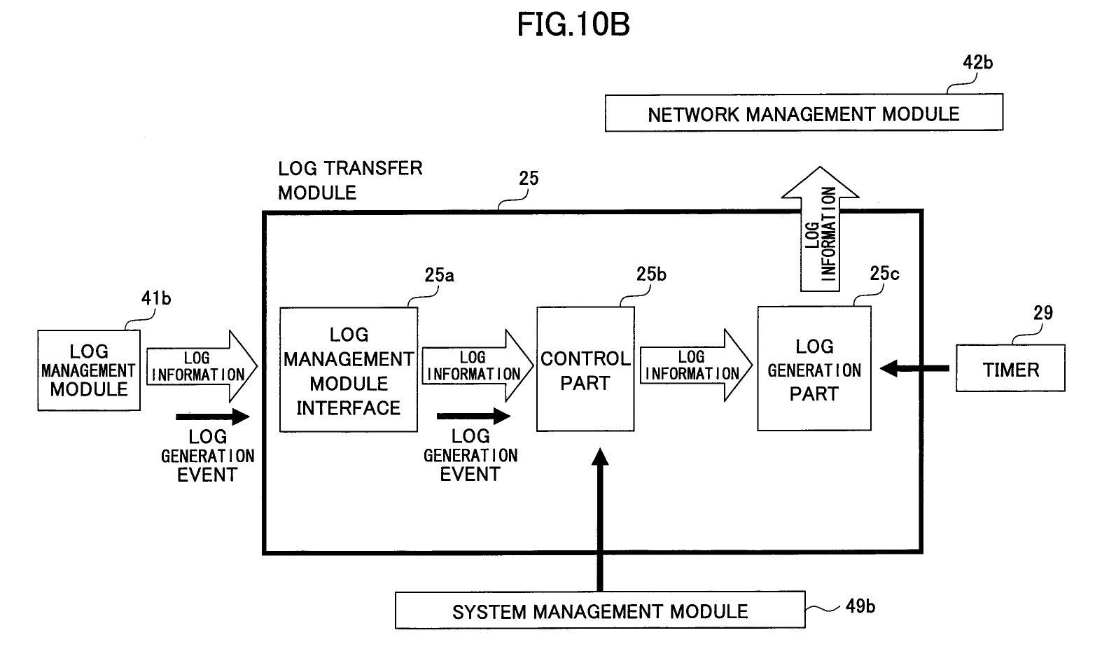

Next, module relationships from a log generation to a log transfer in the image processing apparatus 100 will be described with reference to FIG. 10 through FIG. 12.

Module relationships concerning an event occurrence in each of the applications 21 through 24 and the log transfer module 25 will be described with reference to FIG. 10A and FIG. 10B. A module relationship concerning the regular log when an event occurs in each of the applications 21 through 25 will be described with reference to FIG. 10A. The applications 21, 22, 23, and 24 include event occurrence modules 21a, 22a, 23a, and 24a for occurring an event with respect of an execution of a process, respectively. Moreover, the SCS 49 manages various setting values concerning the periodical transfer and the successive transfer, and also includes a system management module 49b for instructing the log transfer module 25 based on the setting values. The LCS 41 includes a log management module 41b for generating a log in response to a notice of the event occurrence. The NCS 42 includes a network management module 42b for conducting the log transfer to the log collecting server 3.

In FIG. 10A, the system management module 49b of the SCS 49 instructs the log transfer module 25 to conduct the periodical transfer and the successive transfer. Each of the event occurrence modules 21a through 24a respective to the applications 21 through 24 informs an event to the log management module 41b.

The log management module 41b analyses each event informed from the event occurrence modules 21a through 24a, generates a log in response to the event, and informs a log generation event to the log transfer module 25. The log transfer module 25 requests the network management module 42b of the NCS 42 to transfer the log by corresponding to the log type in accordance with an instruction from the system management module 49b of the SCS 49, in response to the log generation event.

The network management module 42b of the NCS 42 sends the logs to the log collecting server 3 through the network 2, in response to the request from the log transfer module 25.

FIG. 10B is a diagram showing an internal configuration of the log transfer module and explaining a data flow for the regular log, according to the embodiment of the present invention. In FIG. 10B, the log transfer module 25 includes a log management module interface 25a, a control part 25b, and a log generation part 25c.

The log management module interface 25a is an interface for receiving the log generation event and log information from the log management module 41b of the LCS 41. The log management module interface 25a informs the log occurrence and the log information of the control part 25b.

The control part 25b analyses the log information, determines one of the transfer patterns 1 through 5 described above as a log transfer method in accordance with the instruction of the system management module 49b, and sends the log information to the log generation part 25c.

The log generation part 25c generates the log information for the log transfer, and sends the log information to the network management module 42b of the NCS 42.

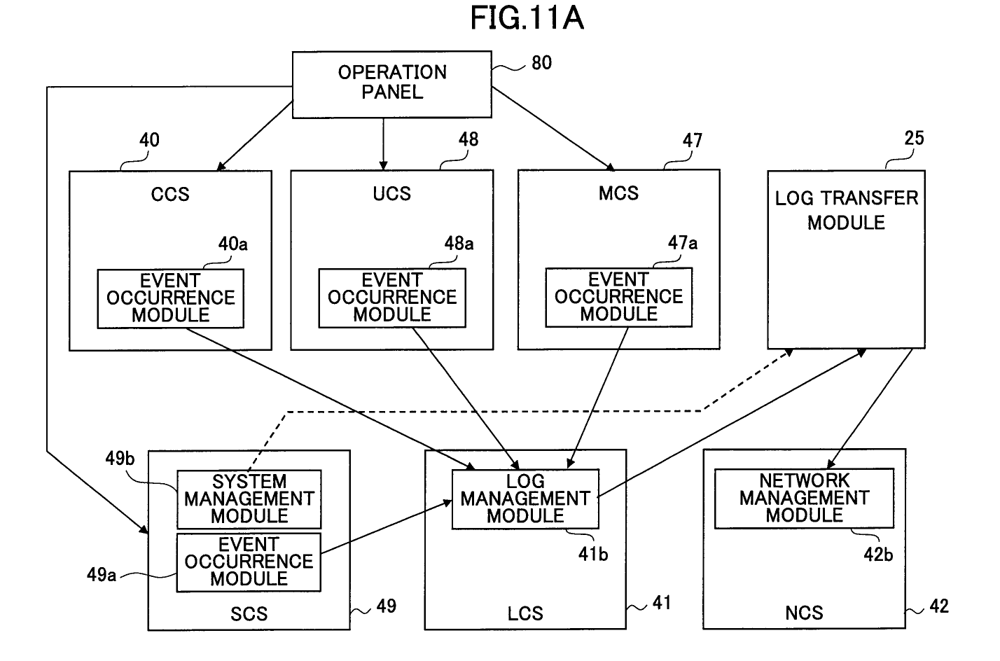

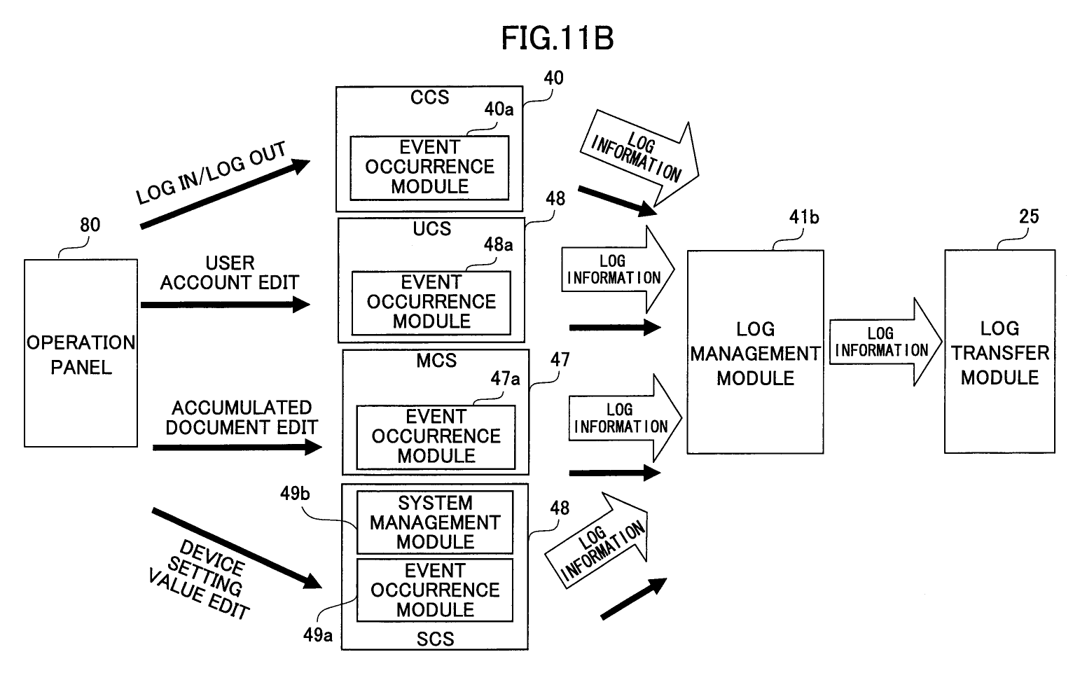

A module relationship in a case in that an event occurs in response to an operation of a user at the operation panel 80 will be described with reference to FIG. 11A and FIG. 11B. The CCS 40, the UCS 48, and the MCS 47 described with reference to FIG. 2, include respectively, event occurrence modules 40a, 48a, and 47a for occurring an event in response to an execution of a process by the operation of the user at the operation panel 80. Also, as described above, the SCS 49, the LCS 41, and the NCS 42 include the system management module 49b, the log management module 41b, and the network management module 42b. The SCS 49 further includes an even occurrence module 49a for occurring an event when the user edits a device setting value at the operation panel 80.

In FIG. 11A, the system management module 49b of the SCS 49 instructs the log transfer module 25 to conduct the periodical transfer and the successive transfer. The event occurrence modules 40a, 48a, 47a, and 49b respective to the CCS 40, the UCS 48, the MCS 47, and the SCS 49 inform an event to the log management module 41b of the LCS 41.

The log management module 41b of the LCS 41 analyses each event informed from the event occurrence modules 40a, 48a, 47a, and 49b, generates a log, and informs a log generation event to the log transfer module 25. The log transfer module 25 requests the log transfer of the network management module 42b of the NCS 42 by corresponding to the log type in accordance with the system management module 49b of the SCS 49. The network management module 42b of the NCS 42 sends log information to the log collecting server 3 through the network 2.

A dataflow of an access log occurred by the operation of the user, in which each of the event occurrence modules 40a, 48a, 47a, and 49a occurs an event, will be described with reference to FIG. 11B. The log transfer module 25 shown in FIG. 11B includes the functional configuration shown in FIG. 10B.

In FIG. 11B, when the user logs in and logs out at the operation panel 80, the event occurrence module 30a of the CCS 40 occurs an event and informs the log information concerning the login or logout to the log management module 41a.

When the user operates to edit a user account at the operation panel 80, the event occurrence module 48a of the UCS 48 occurs an event and informs the log information concerning the edit of the user account to the log management module 41a.

When the user operates to edit a document accumulated in the image processing apparatus 100 at the operation panel 80, the event occurrence module 47a of the MCS 47 occurs an event and informs the log information concerning the edit of the document accumulated in the image processing apparatus 100 to the log management modules 41a.

When the user operates to edit the device setting value at the operation panel 80, the event occurrence module 49a of the SCS 49 occurs an event and informs the log information concerning the edit of the device setting value to the log management module 41a.

Each of the log information is informed from the log management module 41a to the log transfer module 25, and is transferred by the network management module 42b to the log collecting server 3.

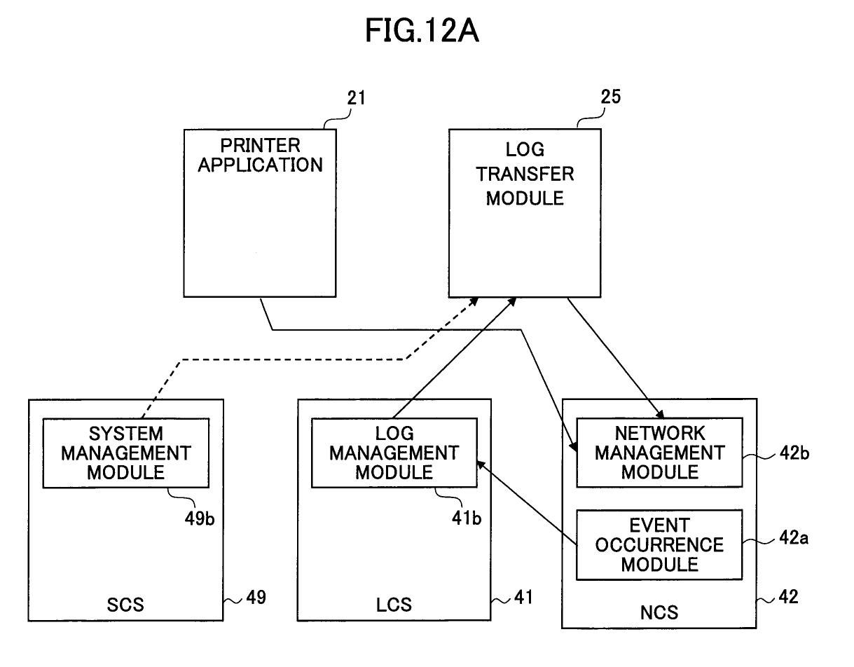

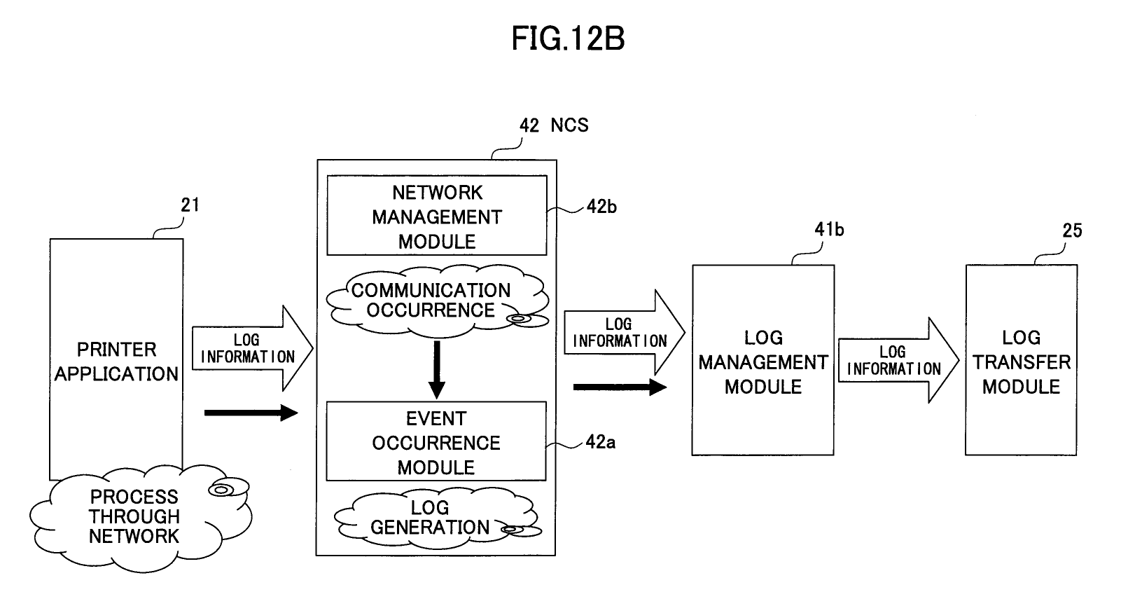

Module relationships concerning an event occurrence in a process requested through the network 2 will be described with reference to FIG. 12A and FIG. 12B. For example, there is a case in which a PC (Personal Computer) connected to the image processing apparatus 100 through the network 2 requests a print process to the image processing apparatus 100.

As describe above, the SCS 49, the LCS 41, and the NCS 42 shown in FIG. 2, include respectively, the system management module 49b, the log management module 41b, and the network management module 42b. The NCS 42 further includes the event occurrence module 42a by which an event occurs when the process requested through the network 2 is conducted.

In FIG. 12A, a module relationship concerning the communication log, in which an event is occurred by the printer application 21, will be described with reference to FIG. 12B. The system management module 49b of the SCS 49 instructs the log transfer module 25 to conduct the periodical transfer and the successive transfer. The printer application 21 executes the print process in accordance with a print request received from the PC through the network 2. Then, for example, the printer application 21 requests the network management module 42b of the NCS 42 to send the PC a process result indicating the job end.

After that, the network management module 42b of the NCS 42 occurs an event of the job end informs the event to the log management module 41b of the LCS 41. The log management module 41b of LCS 41 analyses each event informed from the NCS 42, generates a log, and informs a log generation event to the log transfer module 25. The log transfer module 25 requests the network management module 42b of the NCS 42 to conduct the log transfer corresponding to the log type based on the instruction received from the system management module 49b of the SCS 49 in response to the log generation event. The network management module 42b of the NCS 42 transfers the log information indicating the job end to the log collecting server 3 through the network 2.

When the log transfer is completed for the log information indicating the job end, the event occurrence module 42a of the NCS 42 occurs an event of a transfer end and informs the event to the log management module 41b of the LCS 41. The log management module 41b of the LCS 41 analyses each event informed from the NCS 42, generates a log, and informs the log generation event to the log transfer module 25. The log transfer module 25 requests the network management module 42b of the NCS 42 to conduct the log transfer corresponding to the log type based on the instruction received from the system management module 49b of the SCS 49 in response to the log generation event. The network management module 42b of the NCS 42 transfers the log information indicating the transfer end to the log collecting server 3 through the network 2. After that, as described above, the log information concerning the log transfer is repeatedly sent to the log collecting server 3.

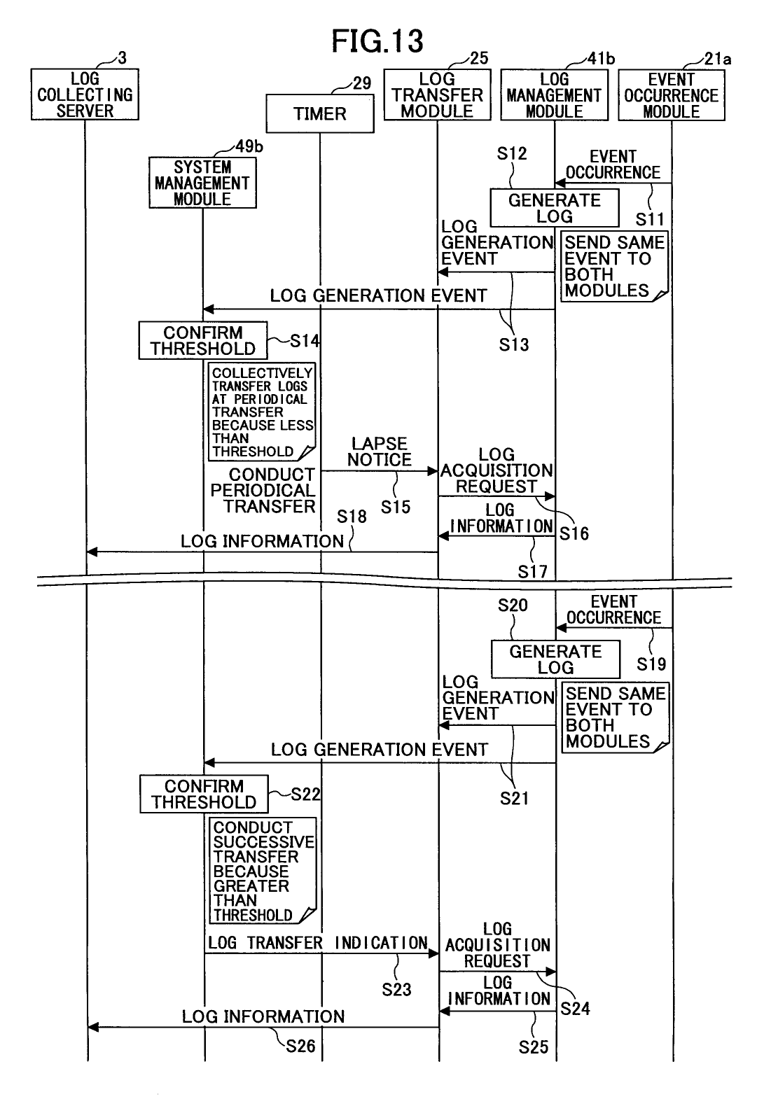

Next, sequences for the transfer patterns 1 through 5 will be described with reference to FIG. 13 through FIG. 18.

FIG. 13 is a diagram showing a sequence example for conducting the transfer pattern 1 shown in FIG. 5, according to the embodiment of the present invention. For the sake of convenience, FIG. 13 illustrates that the log management module 41b receives a notice of the event occurrence from the event occurrence module 21a alone. The log management module 41b may receive the notice of the event occurrence from any one of the event occurrence modules 22a, 23a, 24a, 40a, 42a, 47a, 48a, and 49a when logs of events occurred by the event occurrence modules 22a, 23a, 24a, 40a, 42a, 47a, 48a, and 49a are subjects for the periodical transfer.

In FIG. 13, the event occurrence module 21a informs the event occurrence to the log management module 41b (step S11). The log management module 41b generates the log information (step S12), and sends the same event indicating the log generation to the log transfer module 25 and the system management module 49b (step S13).

The system management module 49b confirms whether or note the accumulation amount of logs is less than or equal to the threshold of the accumulation amount (step S14). When the accumulation amount of logs is less than or equal to the threshold of the accumulation amount, the system management module 49b determines that logs being accumulated in the image processing apparatus 100 are collectively transferred at the time of the periodical transfer, the system management module 49b suppresses instructing the log transfer module 25 to conduct the log transfer. The log transfer is not conducted.

Since the log transfer module 25 does not receive the log transfer instruction from the system management module 49b, when the log transfer module 25 receives a lapse notice informing the time of conducting the periodical transfer from a timer 29 (step S15), the log transfer module 25 sends the log management module 41b a log acquisition request for acquiring the log information (step S16). When log transfer module 25 receives the log information from the log management module 41b (step S17), the log transfer module 25 transfers the log information to the log collecting server 3 (step S18).

While the accumulation amount of logs is less than or equal to the threshold of the accumulation amount, the steps S11 through S18 are repeated and the periodical transfer is conducted.

After that, when the notice of the event occurrence is received from the event occurrence module 21a (step S19), the log management module 41b generates the log information (step S20), and sends the same event indicating the log generation to the log transfer module 25 and the system management module 49b (step S21).

The system management module 49b determines whether or not the accumulation amount of logs is less than or equal to the threshold of the accumulation amount (step S22). When the accumulation amount of logs is greater than the threshold of the accumulation amount, it is determined that the log transfer is switched from the periodical to the successive transfer, and the system management module 49b sends a log transfer instruction to the log transfer module 25 (step S23).

Instead of waiting for the lapse notice from the timer 29 to conduct the periodical transfer, the log transfer module 25 sends the log management module 41b a log acquisition request for acquiring the log information, in accordance with the log transfer instruction received from the system management module 49b (step S24). When the log transfer module 25 receives the log information from the log management module 41b (step S25), the log transfer module 25 transfers the log information to the log collecting server 3 (step S26). As described above, the successive transfer is conducted by switching the log transfer from the periodical transfer.

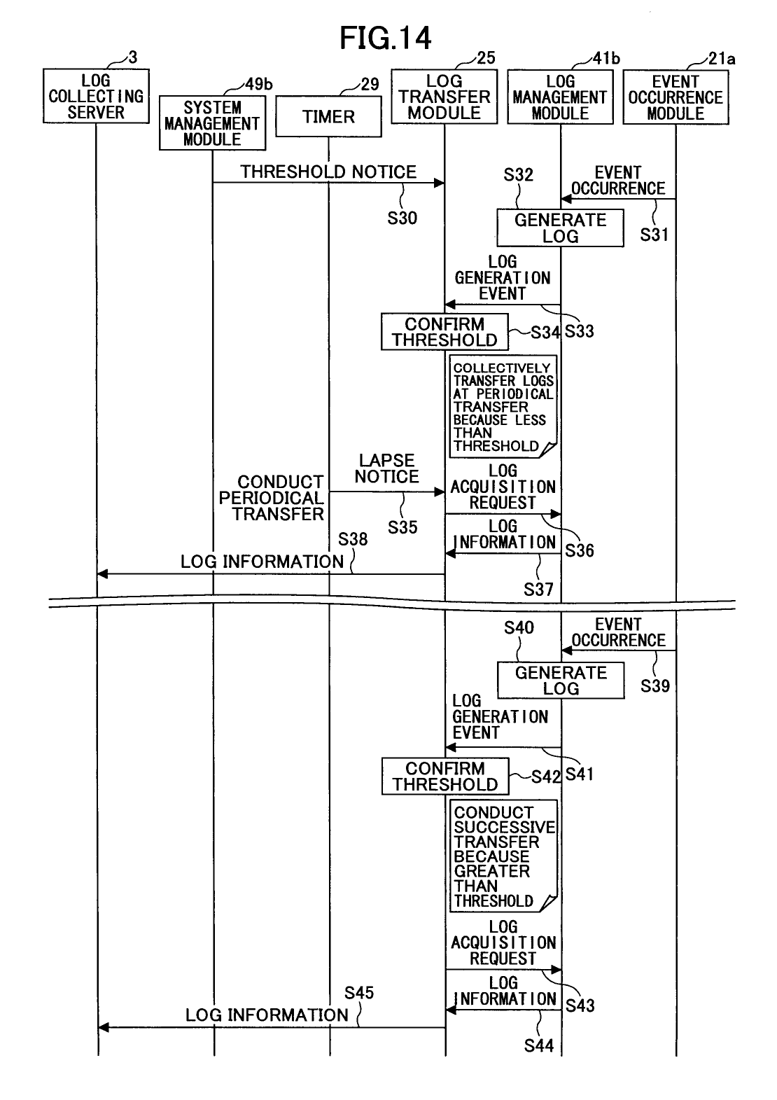

In the sequence example of the transfer pattern 1 shown in FIG. 13, the system management module 49b conducts a confirmation process for confirming the threshold of the accumulation amount. Alternatively, in FIG. 14, the log transfer module 25 conducts the confirmation process for confirming the threshold of the accumulation amount.

FIG. 14 is a diagram showing another sequence example for conducting the transfer pattern 1 shown in FIG. 5, according to the embodiment of the present invention. For the sake of convenience, FIG. 14 illustrates that the log management module 41b receives a notice of the event occurrence from the event occurrence module 21a alone. The log management module 41b may receive the notice of the event occurrence from any one of the event occurrence modules 22a, 23a, 24a, 40a, 42a, 47a, 48a, and 49a when logs of events occurred by the event occurrence modules 22a, 23a, 24a, 40a, 42a, 47a, 48a, and 49a are subjects for the periodical transfer.

In FIG. 14, the system management module 49b informs the threshold of the accumulation amount to the log transfer module 25 beforehand (step S30).

After that, when the log management module 41b receives the notice of the event occurrence from the event occurrence module 21a (step S31), the log management module 41b generates the log information (step S32) and transfers the event indicating the log generation to the log transfer module 25 (step S33).

The log management module 41b determines whether or not the accumulation amount of logs is less than or equal to the threshold of the accumulation amount (step S34). When the accumulation amount of logs is less than or equal to the threshold of the accumulation amount, it is determined that logs accumulated in the image processing apparatus 100 are collectively sent out at the time of the periodical transfer, and the log management module 41b wais for the lapse notice from the timer 29 to conduct the periodical transfer.

When the log transfer module 25 receives the lapse notice informing the time of conducting the periodical transfer from the timer 29 (step S35), the log transfer module 25 sends a log acquisition request for acquiring the log information, to the log management module 41b (step S36). When the log transfer module 25 receives the log information from the log management module 41b (step S37), the log transfer module 25 transfers the log information to the log collecting server 3 (step S38).

While the accumulation amount of logs maintains less than or equal to the threshold of the accumulation amount, the steps S31 through S38 are repeated and the periodical transfer is conducted.

After that, when the notice of the event occurrence is received from the event occurrence module 21a (step S39), the log management module 41b generates the log information (step S40) and sends the event indicating the log generation to the log transfer module 25 (step S41).

The log transfer module 25 determines whether or not the accumulation amount of logs is less than or equal to the threshold of the accumulation amount (step S42). When the accumulation amount of logs is greater than the threshold, it is determined that the log transfer is switched from the periodical transfer to the successive transfer, the log transfer module 25 sends the log management module 41b a log acquisition request for acquiring the log information, instead of waiting for the lapse notice from the timer 29 to conduct the periodical transfer (step S43). When the log transfer module 25 receives the log information from the log management module 41b (step S44), the log transfer module 25 transfers the log information to the log collecting server 3 (step S45). As described above, the successive transfer is conducted by switching from the periodical transfer.

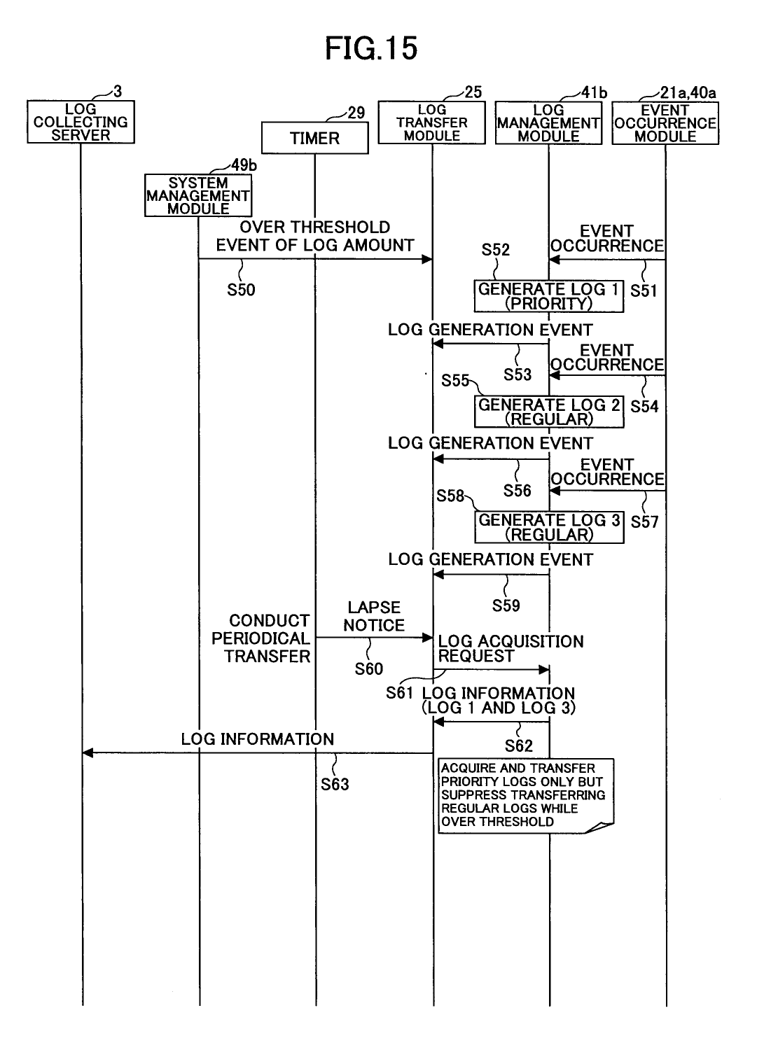

FIG. 15 is a diagram showing a sequence example for conducting the transfer pattern 2 shown in FIG. 6, according to the embodiment of the present invention. For the sake of convenience, FIG. 15 illustrates that the log management module 41b receives notices of the event occurrences only from the event occurrence modules 21a and 40a. The log management module 41b may receive the notice of the event occurrence from any one of the event occurrence modules 22a, 23a, 24a, 42a, 47a, 48a, and 49a when logs of events occurred by the event occurrence modules 22a, 23a, 24a, 42a, 47a, 48a, and 49a are subjects for the periodical transfer.

For example, in a case of determining the access log and the communication log as a priority log, instead of the event occurrence module 40a, any one of event occurrence modules 42a, 47a, 48a, and 49a can be applied.

In FIG. 15, when it is determined that the accumulation amount exceeds the threshold of the accumulation amount in conducting the periodical transfer, the system management module 49b informs an event indicating that the accumulation amount exceeds the threshold, to the log transfer module 25 (step S50).

After that, when the log management module 41b receives the notice of the event occurrence from the event occurrence module 40a (step S51), the log management module 41b generates the log information of a Log 1 being the priority log (step S52), and sends the event indicating the log generation to the log transfer module 25 (step S53).

Next, when the log management module 41b receives the notice of the event occurrence from the event occurrence module 21a (step S54), the log management module 41b generates the log information of a Log 2 being the regular log (step S55), and sends the event indicating the log generation to the log transfer module 25 (step S56).

Moreover, when the log management module 41b receives the notice of the event occurrence from the event occurrence module 40a (step S57), the log management module 41b generates the log information of a Log 3 being the priority log (step S58), and sends the event indicating the log occurrence to the log transfer module 25 (step S59).

After that, when the log transfer module 25 receives the lapse notice informing the time of conducting the periodical transfer from the timer 29 (step S60), the log management module 41b sends the log acquisition request for acquiring the log information, to the log management module 41b (step S61). In this case, since the log transfer module 25 receives the event indicating that the accumulation amount exceeds the threshold (hereinafter, simply called over threshold), from the system management module 49b, the log transfer module 25 requests only priority logs to the log management module 41b.

When the log transfer module 25 receives the log information of the Log 1 and the Log 3 from the log management module 41b (step S62), the log transfer module 25 transfers the log information of the Log 1 and the Log 3 to the log collecting server 3 (step S63).

After that, the log management module 41b repeats the same process described above and transfers the log information of the priority logs to the log collecting server 3 until receiving an event indicating that the over threshold is released from the system management module 49b.

In the step S50 described above, alternatively, the log transfer module 25 may confirm to the system management module 49b whether or not the accumulation amount of logs exceeds the threshold. As shown in FIG. 13 and FIG. 14, the system management module 49b or the log transfer module 25 may conduct a comparison and confirmation of a current accumulation amount and the threshold of the accumulation amount.

Moreover, in the steps S61 and S62 described above, alternatively, the log transfer module 25 may acquire the log information for all log occurrence events received from the log management module 41b, from the log management module 41b. Then, the log transfer module 25 itself analyses the log type and transfers the log information of only the priority logs to the log collecting server 3.

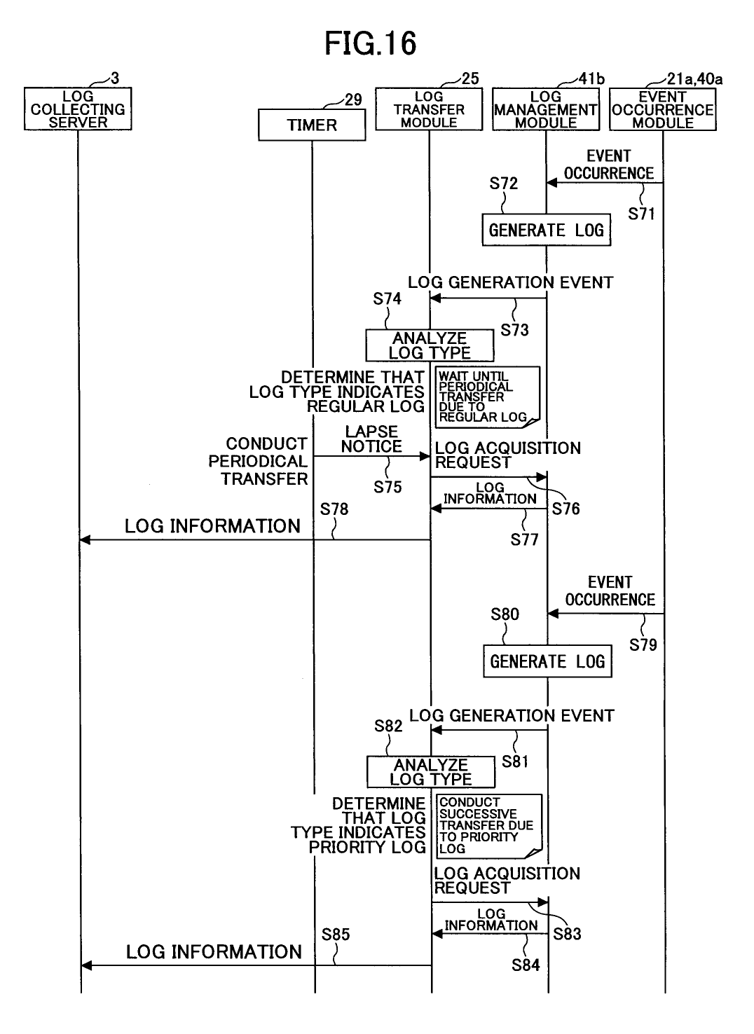

FIG. 16 is a diagram showing a sequence example for conducting the transfer pattern 3 shown in FIG. 7, according to the embodiment of the present invention. For the sake of convenience, FIG. 16 illustrates that the log management module 41b receives notices of the event occurrences only from the event occurrence modules 21a and 40a. The log management module 41b may receive the notice of the event occurrence from any one of the event occurrence modules 22a, 23a, 24a, 42a, 47a, 48a, and 49a when logs of events occurred by the event occurrence modules 22a, 23a, 24a, 42a, 47a, 48a, and 49a are subjects for the periodical transfer.

For example, in a case of determining the access log and the communication log as a priority log, instead of the event occurrence module 40a, any one of event occurrence modules 42a, 47a, 48a, and 49a can be applied.

In FIG. 16, the log transfer module 25 analyses the log type. When the log management module 41b receives the notice of the event occurrence from the event occurrence module 21a (step S71), the log management module 41b generates the log information (step S72) and sends the event indicating the log generation to the log transfer module 25 (step S73).

The log transfer module 25 analyses the log type (step S74). When it is determined that the regular log is generated, the log transfer module 25 waits for a next periodical transfer to transfer the regular log.

After that, when the log transfer module 25 receives the lapse notice informing the time of conducting the periodical transfer from the timer 29 (step S75), the log transfer module 25 sends the log management module 41b the log acquisition request for acquiring the log information (step S76). When the log transfer module 25 receives the log information from the log management module 41b (step S77), the log transfer module 25 sends the log information to the log collecting server 3 (step S78).

After that, when the log management module 41b receives the notice of the event occurrence from the event occurrence module 40a (step S79), the log management module 41b generates the log information (step S80), and sends the event indicating the log generation to the log transfer module 25 (step S81).

The log transfer module 25 analyses the log type (step S82). When it is determined that the priority log is generated, instead of waiting of the lapse notice from the timer 29 to conduct the periodical transfer, the log transfer module 25 sends the log management module 41b the log acquisition request for acquiring the log information (step S83). When the log transfer module 25 receives the log information from the log management module 41b (step S84), the log transfer module 25 transfers the log information to the log collecting server 3 (step S85).

As described above, the log transfer module 25 analyses, transfers the regular log to the log collecting server 3 by the periodical transfer, and transfers the priority log to the log collecting server 3 by the successive transfer. Therefore, it is possible for the administrator to timely comprehend contents of the priority log.

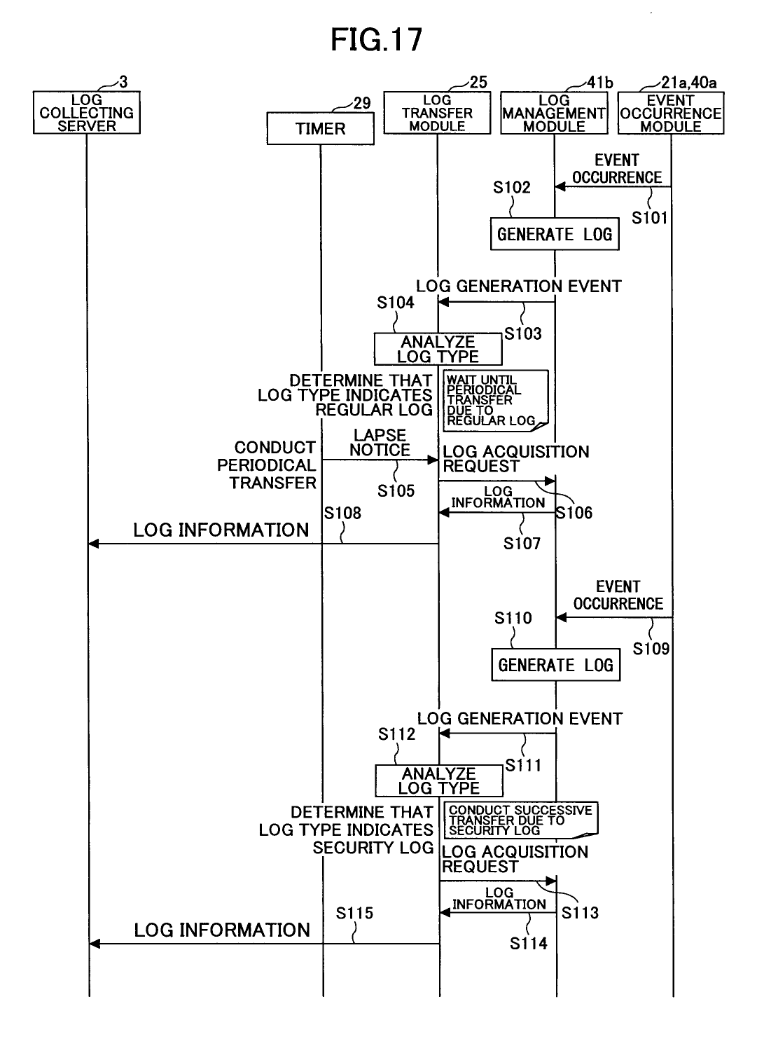

FIG. 17 is a diagram showing a sequence example for conducting the transfer pattern 1 shown in FIG. 8, according to the embodiment of the present invention. For the sake of convenience, FIG. 17 illustrates that the log management module 41b receives notices of the event occurrences only from the event occurrence modules 21a and 40a. The log management module 41b may receive the notice of the event occurrence from any one of the event occurrence modules 22a, 23a, 24a, 42a, 47a, 48a, and 49a when logs of events occurred by the event occurrence modules 22a, 23a, 24a, 42a, 47a, 48a, and 49a are subjects for the periodical transfer.

In the sequence example shown in FIG. 17, in a case in which it is set to transfer a log concerning security by the successive transfer, the successive transfer is conducted to transfer the security log requiring a security management such as the access log, the job log, and the communication log indicating the job end other than the transfer end, and the periodical transfer is conducted to transfer the communication log, which is generated at every log transfer, such as the log indicating the transfer end in the log types of the communication logs.

In FIG. 17, when the log management module 41b receives the notice of the event occurrence from the event occurrence module 21a (step S101), the log management module 41b generates the log information (step S102) and transfers the event indicating the log occurrence to the log transfer module 25 (step S103).

The log transfer module 25 analyses the log type (step S104). When it is determined that the communication log indicating the transfer end is generated, the log transfer module 25 waits for the next periodical transfer in order to transfer the communication log.

After that, when the log transfer module 25 receives the lapse notice from the timer 29 to conduct the periodical transfer (step S105), the log transfer module 25 sends the log management module 41b the log acquisition request for acquiring the log information (step S106). When the log transfer module 25 receives the log information from the log management module 41b (step S107), the log transfer module 25 transfers the log information to the log collecting server 3 (step S108).

After that, when the log management module 41b receives the notice of the event occurrence from the event occurrence module 40a (step S109), the log management module 41b generates the log information (step S110) and sends the event indicating the log occurrence to the log transfer module 25 (step S111).

The log transfer module 25 analyses the log type (step S112). When it is determined that the security log is generated, instead of waiting for the lapse notice from the timer 29 to conduct the periodical transfer, the log transfer module 25 sends the log management module 41b the log acquisition request for conducting the log acquisition request (step S113). When the log transfer module 25 receives the log information from the log management module 41b (step S114), the log transfer module 25 transfers the log information to the log collecting server 3 (step S115).

As described above, the log transfer module 25 analyses the log type and transfers the communication log, which is generated at every log transfer, by the periodical transfer, instead of the successive transfer. Therefore, it is possible to reduce the frequency of the network communication.

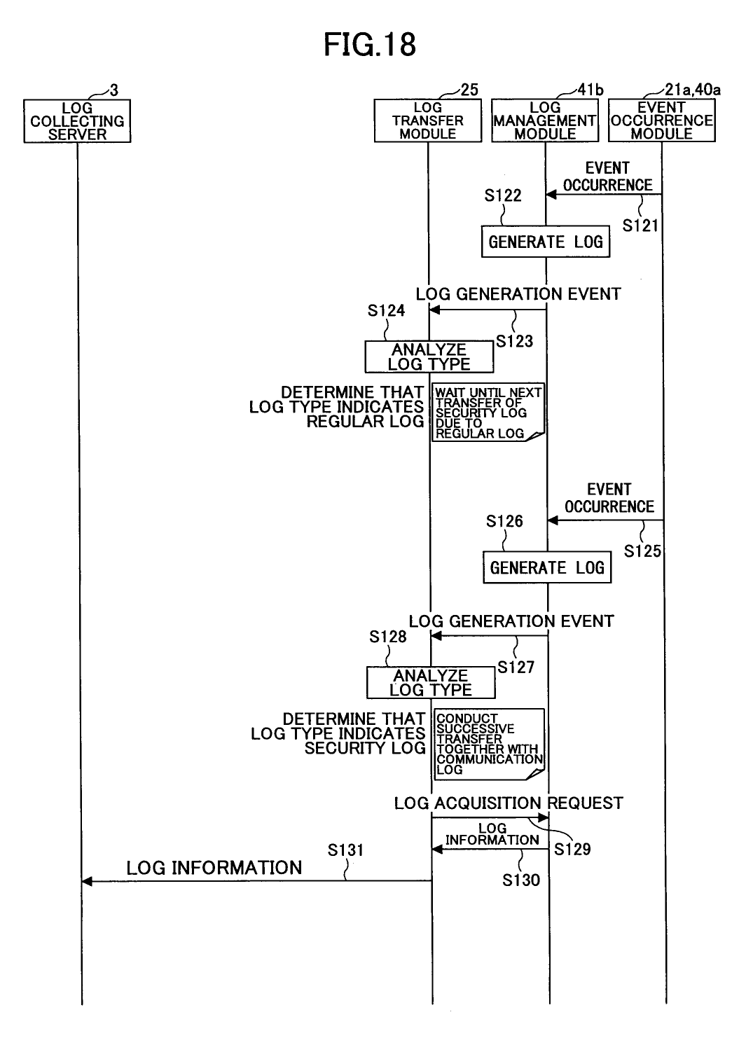

FIG. 18 is diagram showing a sequence example for conducting the transfer pattern 5 shown in FIG. 9, according to the embodiment of the present invention. For the sake of convenience, FIG. 18 illustrates that the log management module 41b receives notices of the event occurrences only from the event occurrence modules 21a and 40a. The log management module 41b may receive the notice of the event occurrence from any one of the event occurrence modules 22a, 23a, 24a, 42a, 47a, 48a, and 49a when logs of events occurred by the event occurrence modules 22a, 23a, 24a, 42a, 47a, 48a, and 49a are subjects for the periodical transfer.

In the sequence example shown in FIG. 18, in a case in which it is set to transfer a log concerning security by the successive transfer, the successive transfer is conducted to transfer the security log requiring a security management such as the access log, the job log, and the communication log indicating the job end other than the transfer end. At a next successive transfer, the communication log, which is generated at every log transfer, such as the log indicating the transfer end in the log types of the communication logs, is transferred together with the above-described security log.

In FIG. 18, when the log management module 41b receives the notice of the event occurrence from the event occurrence module 21a (step S121), the log management module 41b generates the log information (step S122) and transfers the event indicating the log generation to the log transfer module 25 (step S123).

The log transfer module 25 analyses the log type (step S124). When it is determined that the communication log indicating the transfer end is generated, the log transfer module 25 transfers the communication log together with a next security log by the successive transfer for the next security log.

After that, when the notice of the event occurrence is received from the event occurrence module 40a (step S125), the log management module 41b generates the log information (step S126) and transfers the event indicating the log occurrence to the log transfer module 25 (step S127).

The log transfer module 25 analyses the log type (step S128). When it is determined that the security log is generated, the log transfer module 25 sends the log management module 41b the log acquisition request for acquiring the log information (step S113). When the log transfer module 25 receives the log information of the communication log and the security log from the log management module 41b (step S114), the log transfer module 25 transfers the log information to the log collecting server 3 (step S115).

As described above, the log transfer module 25 analyses the log type, so that the communication log, which is generated at every log transfer, is transferred together with a next security log by the successive transfer for the next security log. Therefore, it is possible to reduce the frequency of the network communication.

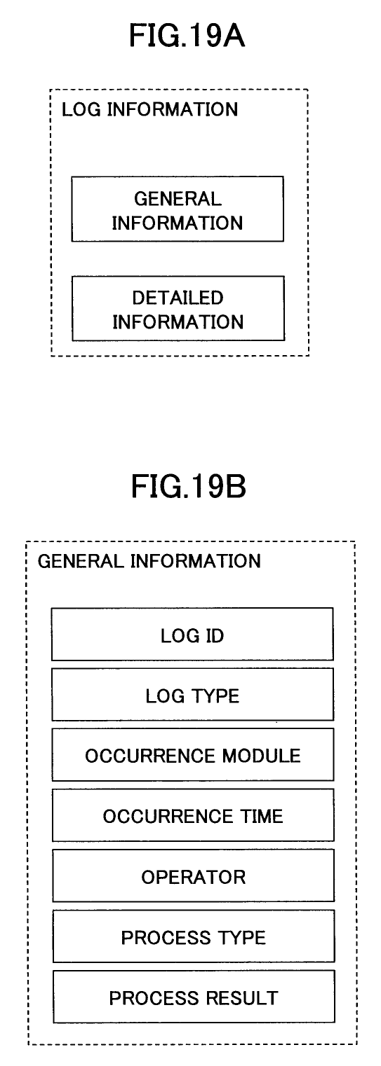

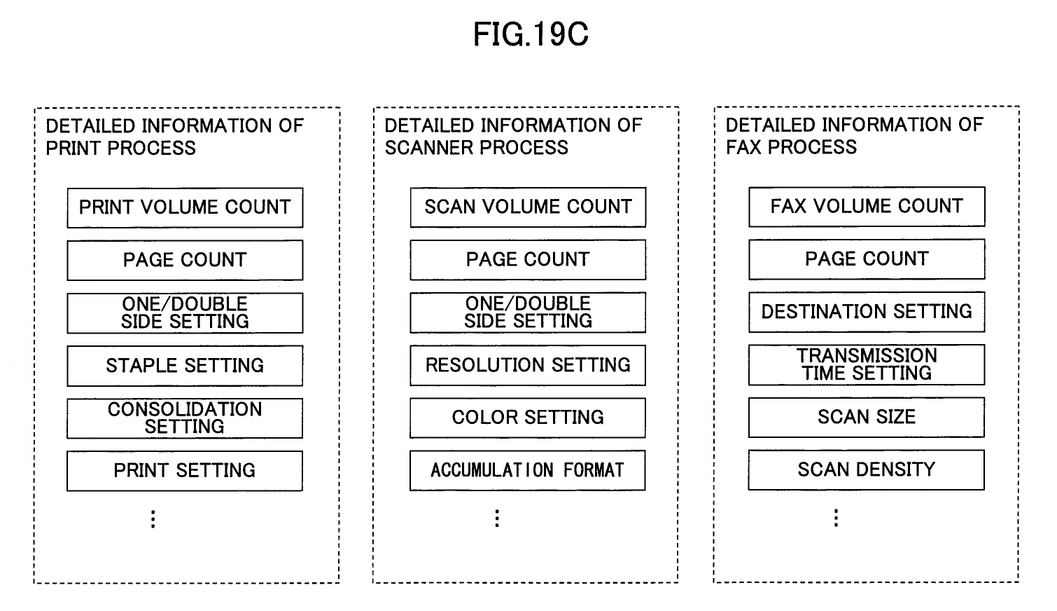

FIG. 19A, FIG. 19B and FIG. 19C are diagrams showing data structures of the log information according to the embodiment of the present invention. As shown in FIG. 19A, the log information mainly includes general information and detailed information, which are structured by the log management module 41b. The general information is information specifying a log and is additionally provided in common for all operations. The detailed information is information indicating contents of each process and is sent in a structured format from each of the event occurrence modules 21a, 22a, 23a, 24a, 40a, 42a, 47a, 48a, and 49a to the log management module 41b.

As shown in FIG. 19B, the general information includes items of a log ID, a log type, an occurrence module, a occurrence time, an operator, a process type, a process result, and a like. The item of the log ID is an identification identifying a log. The item of the log type is an identification indicating a type of the log. The item of the occurrence module specifies a module which conducted a generation process of the log. The item of the occurrence time indicates a time when the log is occurred. The item of the operator indicates user identification information for identifying a user who executed a process. The item of the process type indicates a type of the process executed by the user. The item of the process result indicates a normal end or failure resulted from executing the process.

The log types are mainly classified into two types, the regular log and the priority log. The log types classified into the regular log and the priority log are set by the user. For example, the regular log is a log concerning a process concerning a document operation at the image processing apparatus 100, and an operation which does not require the security. The regular log is a subject to the periodical transfer. In addition, the priority log is a log concerning information required for the administrator, and an operation to which the security management is required. The priority log is a subject to the successive transfer.

In job logs generated by an operation at the image processing apparatus 100, for example, the regular log as one of the job logs is a log being lower security for a job which is not conducted through the network 2 or a device information reference log concerning a reference of device information stored in the image processing apparatus 100.

The priority log is a log being higher security for a job such as a process conducted through the network 2, the access log of an access at the operation panel 80 or an access to the image processing apparatus 100 through the network 2, the communication log of a communication conducted to the image processing apparatus 100, or a device information change log concerning a change or a delete of the device information stored in the image processing apparatus 100.

For example, the detailed information corresponding to the process type is information shown in FIG. 19C. When the process type indicates the print process, the detailed information includes items of a print volume count, a page count, an one/double side setting, a staple setting, a consolidation setting, a print setting, and a like.

Moreover, when the process type indicates the scanner process, the detailed information includes items of scan volume count, a page count, an one/double side setting, a resolution setting, a color setting, an accumulation format, and a like.

Furthermore, when the process type indicates the FAX process, the detailed information includes items of a FAX volume count, a page count, a destination setting, a transmission time setting, a scan size, a scan density, and a like.

As described above, according to the present invention, in the log transfer such as the periodical transfer and the successive transfer, a transfer timing is changed based on the accumulation amount of logs or the log type which causes the network load. Therefore, it is possible to reduce the network load by the log transfer.

According to the above-described embodiment, the log transfer module 25 is one example of a log transfer part, and the log type indicating the threshold of the accumulation amount with respect to the accumulation amount of logs or the log being higher priority is one example of identifying a factor of the network load.

Accordingly, it is possible to provide the image processing apparatus 100 which can reduce the network load caused by the accumulation amount of logs (indicating an amount of log information) and a communication frequency in a log transfer process for transferring the log information to the log collecting server connected through the network 2.

The present application is based on the Japanese Priority Patent Application No. 2006-248613 filed Sep. 13, 2006, the entire contents of which are hereby incorporated by reference.

What is claimed is:

1. An image processing apparatus, comprising:
a log transfer part configured to transfer log information; and
a transfer method changing part configured to change a transfer method used by said log transfer part, based on a factor of a network load caused by a log transfer.

2. The image processing apparatus as claimed in claim 1, wherein a transfer interval is set to be shorter by corresponding to an accumulation amount of logs which is the factor of the network load.

3. The image processing apparatus as claimed in claim 2, wherein the log transfer is changed from a periodical transfer to a successive transfer, so as to set the transfer interval to be shorter to conduct the log transfer.

4. The image processing apparatus as claimed in claim 1, wherein only a log being higher priority is transferred based on an accumulation amount of logs which is the factor of the network load.

5. The image processing apparatus as claimed in claim 4, wherein in a periodical transfer, a log other than the log being higher priority is transferred at a next periodical transfer.

6. The image processing apparatus as claimed in claim 1, wherein a security log is transferred at a shorter transfer interval.

7. The image processing apparatus as claimed in claim 6, wherein in a periodical transfer, the security log is transferred by changing the log transfer method to a successive transfer.

8. The image processing apparatus as claimed in claim 1, wherein in communication logs transferred as security logs, a communication result log indicating a communication result is transferred by a different log transfer from a log transfer for transferring other communication logs.

9. The image processing apparatus as claimed in claim 8, wherein the communication log other than the communication result log is transferred by a successive transfer, and the communication result log is transferred by a periodical transfer.

10. The image processing apparatus as claimed in claim 8, wherein when the communication log other than the communication result log is transferred, the communication result log is transferred together with the communication log.

11. A log transfer method, comprising:
transferring log information; and
changing a transfer method used in transferring log information, based on a factor of a network load caused by a log transfer.

12. The log transfer method as claimed in claim 11, wherein a transfer interval is set to be shorter by corresponding to an accumulation amount of logs which is the factor of the network load.

13. The log transfer method as claimed in claim 11, wherein a log being higher priority is first transferred based on the accumulation amount of logs which is the factor of the network load.

14. The log transfer method as claimed in claim 11, wherein in communication logs transferred as security logs, a communication result log indicating a communication result is transferred by a different log transfer from a log transfer for transferring other communication logs.
